(19) United States
(12) Patent Application Publication
(10) Pub. No.: US 2010/0126593 A1
(43) Pub. Date: May 27, 2010

(54) HOT TAPPING MACHINE

(75) Inventor: Richard Silk, Derbyshire (GB)

Correspondence Address: BURR & BROWN, PO BOX 7068, SYRACUSE, NY, 13261-7068, US

(73) Assignee: MIRAGE MACHINES LIMITED, Derby (GB)

(21) Appl. No.: 12/528,672

(22) PCT Filed: Feb. 25, 2008
(86) PCT No.: PCT/GB2008/000634

§ 371 Date: Jan. 25, 2010

(30) Foreign Application Priority Data
Feb. 26, 2007 (GB) 0703716.1

(51) Int. Cl. F16L 41/04

(52) U.S. Cl. 137/318

(57) ABSTRACT

The present invention provides a hot tapping machine in which the cutter is rotated to cut a coupon from a pipeline by a drive mechanism located at the end of the machine closest to the pipeline. The cutter is advanced towards the pipeline by a second drive mechanism which can be located at the end of the machine remote from the pipeline.

### BACKGROUND

a. Field of the Invention

The present invention relates to a hot tapping machine, and in particular to a hot tapping machine for use in the oil and gas industry.

b. Background to the Invention

Hot tapping, sometimes referred to as under pressure drilling, is a technique that is used to drill into pipes or vessels that contain fluids under pressure. Hot tapping is normally carried out in order to connect a new branch to an existing pipeline without disrupting the flow of fluid within the pipeline and without losing significant quantities of the fluid being carried within the pipeline. For example, if a valve jams in the closed position, hot tapping will be used to bypass the jammed valve and to enable the flow of fluid to be re-enabled. Hot tapping is typically carried out under pressures of a few atmospheres up to 1400 psi (9650 kPa), but these pressures may be much higher.

### SUMMARY OF THE INVENTION

According to the invention, there is provided a hot tapping machine having an elongate body with a first end and a second end, a spindle bar mounted within the body for axial and rotational movement relative to the body, the spindle bar being adapted to carry at one end a cutting head for cutting a hole in a pipeline and the axial movement being such as to extend the spindle bar out of the first end of the body, wherein separate drive motors are provided for driving the axial movement and the rotational movement, and the drive for rotational movement is mounted adjacent the first end of the body.

In use, the first end of the body will be closest to the pipeline into which a hot tapping is to be made, and the second end will be remote from the pipeline.

Preferably the drive for axial movement is mounted adjacent the second end of the body.

By placing the rotational drive as close as possible to the point where cutting will take place, build up of torque in the spindle bar is reduced, leading to a faster, smoother cut.

In use, the first end of the body will be sealed to the pipeline being tapped into. Preferably, on exposure to pipeline pressure after the hole has been cut, that pressure will flow throughout the interior of the body, so that equal and opposite pressures will act on both sides of the axial drive means. As a result, no internal sealing between the spindle bar and the body is required.

The axial movement is preferably produced by mounting a feed screw internally of the spindle bar and fitting a feed nut to the end of the bar within the body. Rotation of the feed screw then causes the feed nut and the spindle bar to travel axially along the length of the body. A motor (preferably a hydraulic motor) can be provided to rotate the feed screw and additionally a manually operable rotation device can be coupled to the screw, so that the spindle bar can be advanced under manual control.

Within the body, guide rods can extend from end to end of the body, and the feed nut can be slidably mounted on these guide rods to prevent the feed screw from rotating. The guide rods can be circular section rods which are tensioned between caps at the opposite ends of the body, and these rods can pass through appropriately sized parallel bores in the feed nut.

A transducer can be arranged to monitor (through a Hall Effect sensor or the like) the number of rotations of the feed screw. By knowing the pitch of the thread on the screw, this reading can be converted into an out pout indicating the amount by which the spindle bar has been advanced.

### BRIEF DESCRIPTION OF THE DRAWINGS

FIG. 1 shows a generic illustration of hot tapping;

FIG. 2 is a side view of a hot tapping machine in accordance with the invention;

FIG. 3 is a cross-section through the machine of FIG. 2, on the line A-A;

FIG. 3a is a cross-section through the machine of FIG. 2, on the line B-B:

FIG. 4 is a cross section through the feed nut on the line C-C from FIG. 5;

FIG. 5 is an external view of the feed nut;

FIG. 6 is an end view of the nut of FIGS. 6 and 7, in the direction of arrow D;

FIG. 7 is an external view of part of the axial drive mechanism;

FIG. 8 is a cross-section through the axial drive unit of FIG. 7 on the line E-E;

FIG. 9 Is a section through the rotational drive gearbox on the line F-F from FIG. 10;

FIG. 10 is an end view of the gearbox of FIG. 9; and

FIG. 11 is a perspective view of the means for manual operation of the axial drive.

### DETAILED DESCRIPTION

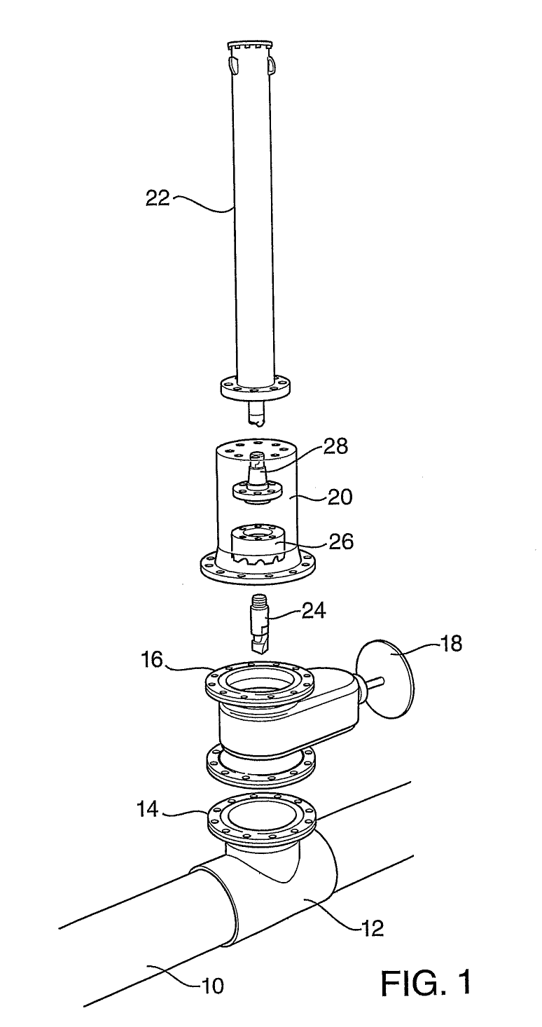

FIG. 1 shows a schematic outline of a hot tapping process. A main pipeline 10 into which a secondary pipe is to be tapped is provided with a sleeve 12 to which a T-joint 14 is welded. The sleeve 12 is welded to the main pipeline 10 at the point where the tap is to be made. The T-piece has a flange, as can be seen. At this stage, the bore of the T-piece 14 is empty because no hole has yet been made in the wall of the main pipeline 10. A valve body 16 with top and bottom flanges is then mounted onto the flange 14. The valve body 16 has a handle 18 which is used to open and close flow through the valve body. At this stage the valve is fully open. Next an adaptor body 20 is mounted to the top flange of the valve body 16, and a hot tapping machine 22 is mounted to the top of the adaptor 20. Shown in exploded view are respectively a pilot drill 24, a cutting body 26 and a boring bar 28. In use these three components will all be secured to the lower end of the hot tapping machine 22.

In use, all these components will be mounted together, in a sealed and pressure tight manner. The hot tapping machine is then operated and the pilot drill 24 and cutting head 26 are advanced through the bore of the valve body 16, through the T-piece 14 and into contact with the surface of the pipeline 10 where the hot tapping machine rotates the cutting bar to cut out a circular disc from the pipeline wall. This circular disc is referred to a “coupon”. The coupon is retained by the pilot drill 24. The cutting head is then withdrawn into the adaptor body 20, and the valve member 18 is then operated to close the valve in the valve body 16. The hot tapping machine and the adaptor 20 can then be removed and a suitable branch pipeline can be attached to the upper flange of the valve body 16, before the valve 18 is re-opened to establish communication through the branch pipeline.

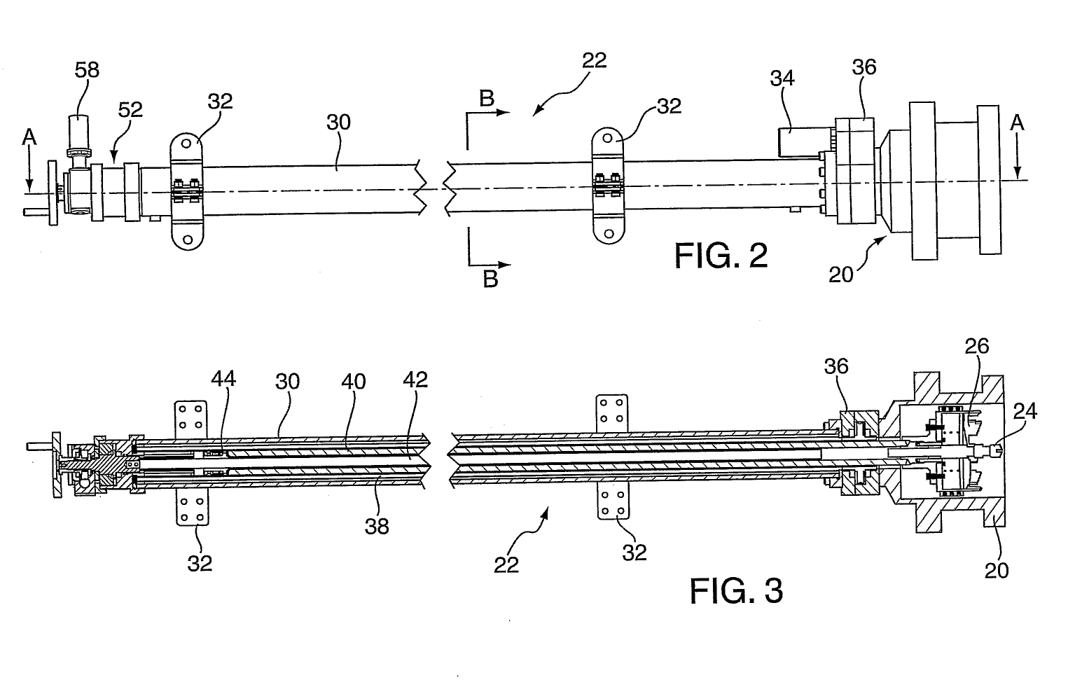

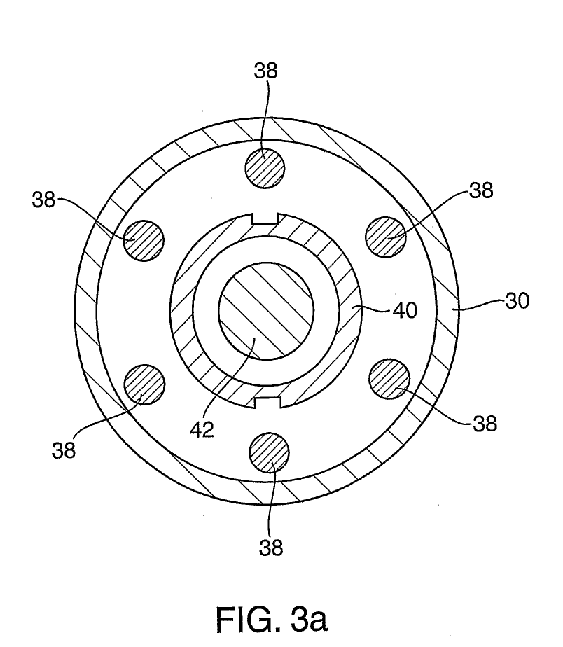

The hot tapping machine 22 will now be described in more detail with reference to the remaining figures of the drawings. FIGS. 2 and 3 show the elongate nature of the hot tapping machine. It will be noted that in these drawings the length of the machine is shown broken away. The elongate part of the machine may need to be very long because, in use, the cutting head may need to be advanced through a number of components such as the adaptor 20, the valve body 16 and the T-piece 14, and the total axial length of these components may be as much as 2 to 3 metres.

The machine has an outer body 30 in the form of a cylindrical tube. FIG. 2 shows, by way of example, two mounting brackets 32 which may be used for securing the machine to a suitable structure.

At the right-hand end of the machine, as seen in FIGS. 2 and 3, an adaptor 20 is shown mounted on the end of the body 30 from which the cutting head 26 will be extended. Adjacent this end of the machine is a drive motor 34 which feeds into a gearbox 36 through which the cutting head 26 will be rotated in a manner to be described.

Along the major part of the body 30, there are a number of guide rods 38, a spindle bar 40 and a feed screw 42. The arrangement of these components is shown in the cross-section of FIG. 3A. The guide rods 38 are stationary and are locked in position at both ends of the body 30 and are tensioned between the ends of the body. The spindle bar 40, which is hollow and carries the cutting head 26, travels axially within the body, and is guided on the guide rods 38, as will be described in more detail. The feed screw 42 is axially stationary but is rotated by another drive motor 58.

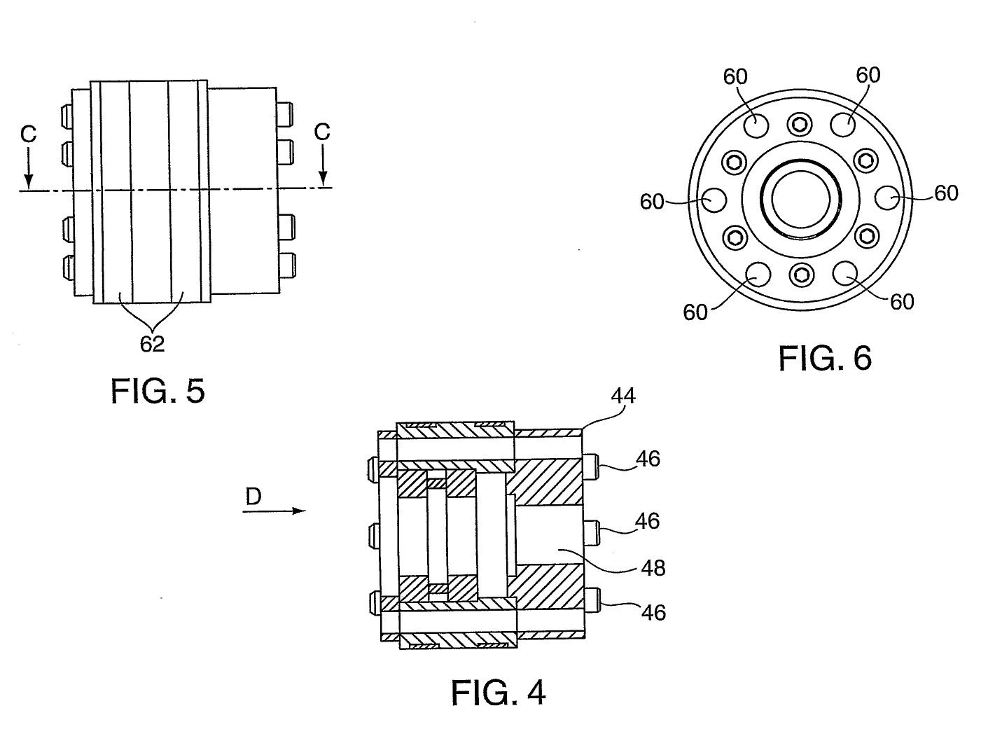

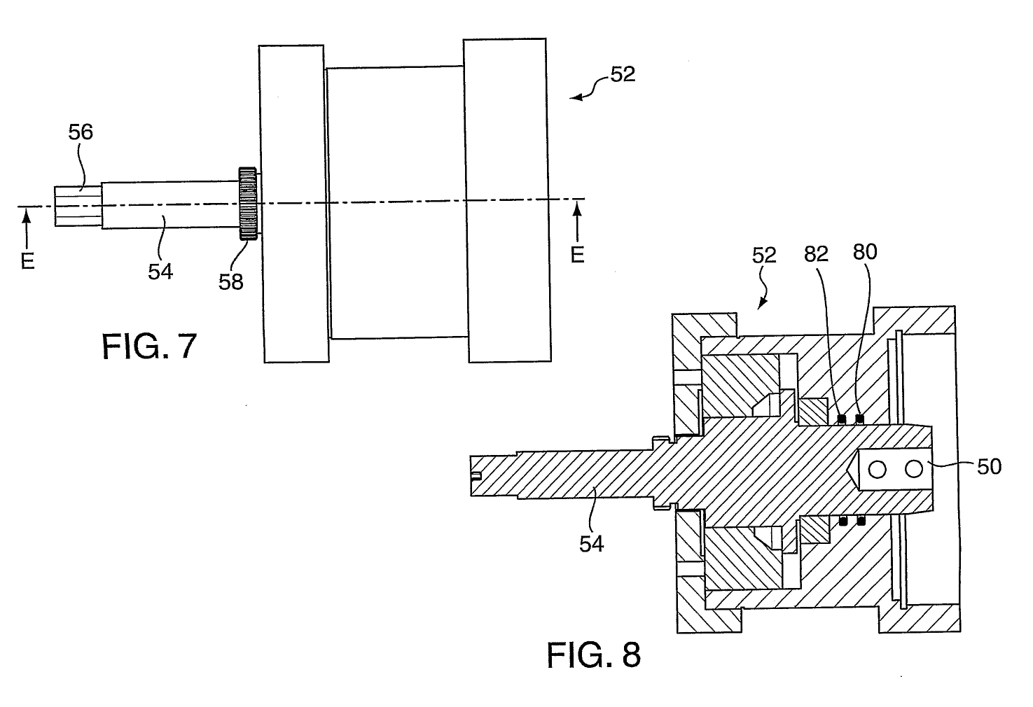

To produce the axial movement of the spindle bar 40, the end of the bar is secured in a feed nut 44 (FIG. 4) by means of bolts 46. The feed nut has a central bore 48 with internal threading which engages with the external threaded surface of the feed screw 42. The feed screw passes right through the feed nut 44 and is attached to a socket 50 in a thrust body 52 (FIGS. 7 and 8) at the left-hand end of the machine. The thrust body 52 has a spindle 54, with a hexagonal boss 56 for connection to a drive mechanism driven by the motor 58. This drive mechanism is not shown in detail but its operation is to rotate a spindle 54 which in turn rotates the feed screw 42. As the feed nut is held against rotation, by being guided on the rods 38, rotation of the feed screw results in the feed nut travelling axially along the screw.

It will be seen that the spindle 54 carries a toothed ring 58, and the teeth on this ring can be counted by a suitable sensor to count the number of revolutions made by the feed screw. Counting these revolutions, together with the knowledge of the pitch of the thread of the feed screw enables a calculation of the distance by which the spindle bar has been advanced to be made. This distance can be displayed on a display module attached to the machine.

The feed nut 52 includes a suitable bearing to absorb the thrust forces which will be passed back up the spindle bar when the machine is cutting into a pipeline surface.

FIG. 6 shows the bores 60 in the feed nut by means of which the feed nut is threaded onto the guide rods 38. The feed nut also has low-friction bands 62 around its circumference to enable it to slide easily within the body 30.

At the right-hand end of the machine, the spindle bar 40 passes through a central bore 62 in the rotation drive gearbox 36. This bore 62 carries splines 64 which locate in corresponding keyways in the external surface of the spindle bar. The rotation is provided by the drive motor 34 which has an output shaft which engages in a socket 66 to drive a pinion 68 which in turn meshes with and drives a final drive pinion 70. The final drive pinion is fixed to a ring 72 which carries the splines 64, and allows the spindle bar to move through the gearbox 36, whilst being rotated by the engagement of the splines 64 in the key ways of the spindle bar. On the right-hand side of the gearbox 36, the spindle bar is connected to a cutting head 26 and a pilot drill 24.

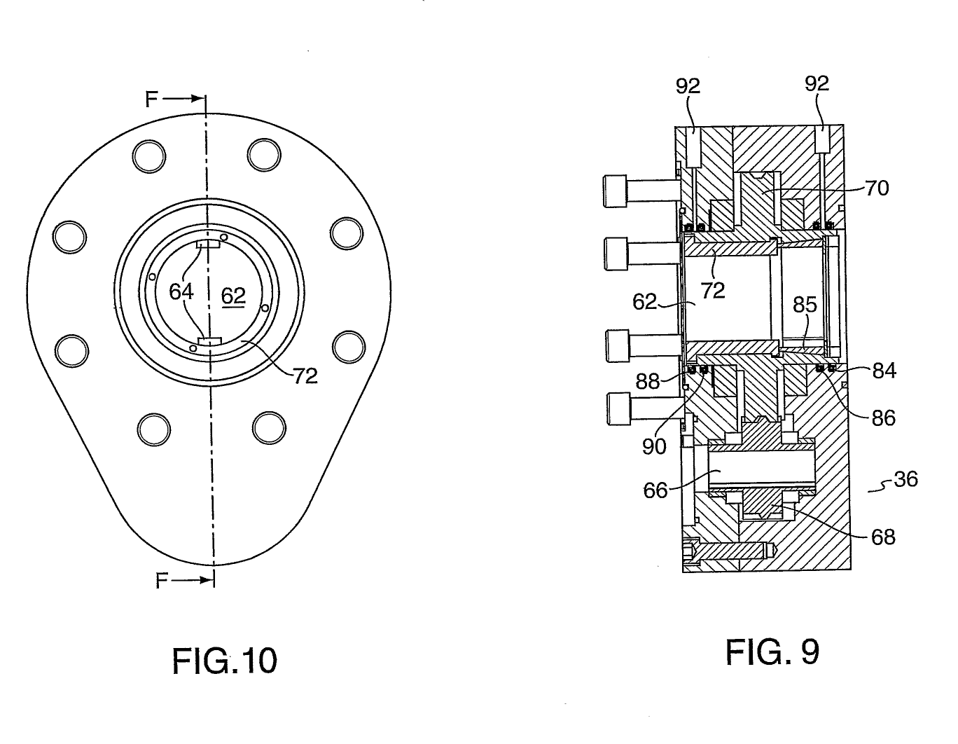

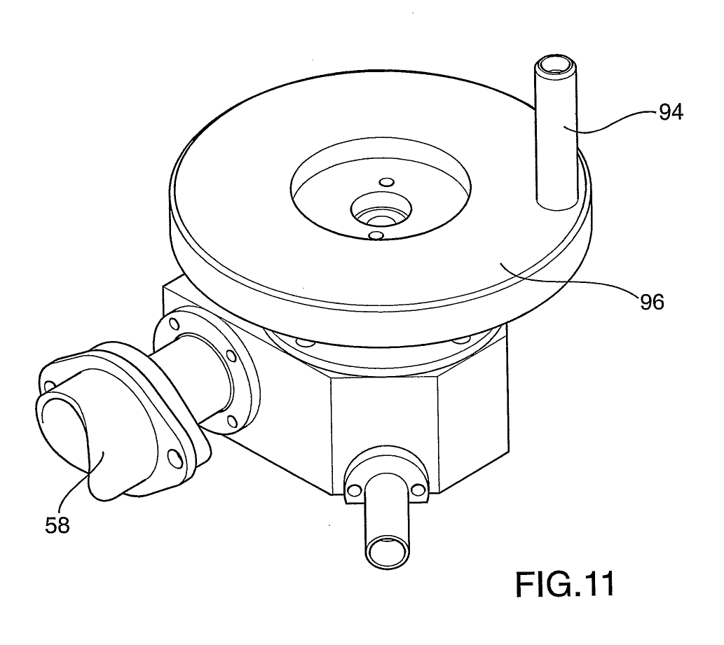

On the exit side of the gearbox 36 (right hand side in FIG. 9), the spindle bar 40 passes through a cone 85 which can be moved in and out of a conical seat to adjust the clearance between the drive gear and the spindle bar to a minimum to remove “bar droop” at extended distances from the gearbox. The cone can be locked in place by a locknut.

When the drill has penetrated the wall of the main pipeline 10, pressurised fluid from inside the pipeline will flow through the valve body 16, through the adapter 20 and into the hot tapping machine. This fluid will flow through the central bore of the gearbox 36, up the body 30 in the outer annulus which contains the guide rods 38, around the feed nut 44 and then down into the inner annulus between the spindle bar 40 and the feed screw 42.

It is important that the seals between the body 30 and the exterior be sufficient to contain this pressure within the body but there is no need to sub-divide the body by internal seals. To seal the body against leakage, the thrust body 52 has seals 80, 82. At the other end of the machine, there are seals at 84, 86, 88 and 90. As these latter seals have to seal between relatively moving parts, seal monitoring ports 92 are provided between the pairs of seals 84, 86 and 88, 90 so that the seal performance can be monitored.

Finally, FIG. 11 shows the drive housing at the left-hand end of the machine, with a manual drive operated by a handle 94 which drives a rotary disc 96 turning the handle 94 to turn the spindle 54 which drives the feed nut along the length of the feed screw and therefore advances the spindle bar towards the right-hand side as seen in FIGS. 2 and 3.

In operation it may be convenient for the spindle bar to be advanced manually until the cutting head 26 (or pilot drill 24) makes initial contact with the surface of the main pipeline to be cut, and then to allow the hydraulic drives 34, 58 to take over to rotate and advance the spindle bar to achieve the necessary cutting. By knowledge of the wall thickness of the pipeline being cut, the distance which the spindle bar has to advance to complete the cut would be known, and by watching the output of the transducer connected to the toothed collar 58, it will be possible to know exactly when to stop feeding the spindle bar any further. Retraction of the bar (which will be done without rotation) and purely by the axial drive 58, 94 can then be activated.

The separation of the axial and rotational drives for the spindle bar allows each to be optimised, and avoids the build up of torque in the bar which would result if the rotational drive of the bar was located at the end of the machine remote from the pipeline.

1. A hot tapping machine having an elongate body with a first end and a second end, a spindle bar mounted within the body for axial and rotational movement relative to the body, the spindle bar being adapted to carry at one end a cutting head for cutting a hole in a pipeline and the axial movement being such as to extend the spindle bar out of the first end of the body, the hot tapping machine further comprising an adaptor mounted to the first end of the body and in which the adaptor is arranged to mount the hot tapping machine relative to the pipeline, wherein separate drive motors are provided for driving the axial movement and the rotational movement, and the drive for rotational movement is mounted adjacent the first end of the body and adjacent the adaptor.

2. A machine as claimed in claim 1, wherein the drive for axial movement is mounted adjacent the second end of the body.

3. A machine as claimed in claim 1 in which the cutting head is arranged, in use, to be withdrawn into the adaptor body.

4. A machine as claimed in claim 1 in which pressurised fluid from inside the pipeline is arranged, in use, to flow into the elongate body.

5. A machine as claimed in claim 1, wherein the body and its internal components are arranged to allow fluid under pressure, from a pipeline into which a hot tapping is made, to flow throughout the body.

6. A machine as claimed in claim 1, wherein a feed screw is mounted internally of the spindle bar within the body, a feed nut is fitted to the end of the bar within the body and means are provided to rotate the feed screw to cause the feed nut and the spindle bar to travel axially along the length of the body.

7. A machine as claimed in claim 6, wherein the means to rotate the feed screw comprises a hydraulic motor.

8. A machine as claimed in claim 6, including a manually operable rotation device coupled to the feed screw, so that the spindle bar can be advanced under manual control.

9. A machine as claimed in claim 6, wherein guide rods extend within the body from end to end of the body, and the feed nut is slidably mounted on these guide rods to prevent the feed screw from rotating.

10. A machine as claimed in claim 9, wherein the guide rods are circular section rods which are tensioned between caps at the opposite ends of the body, and pass through appropriately sized parallel bores in the feed nut.

11. A machine as claimed in claim 1, wherein the drive for rotational movement comprises a hydraulic motor coupled to a gearbox.

12. A machine as claimed in claim 1, wherein a transducer is arranged to monitor the number of rotations of the feed screw, and electronic means are provided to convert the output from the transducer into an output indicating the amount by which the spindle bar has been advanced.

13. A hot tapping machine substantially as herein described with reference to the accompanying drawings.
